(19) United States
(12) Patent Application Publication
(10) Pub. No.: US 2026/0111068 A1
(43) Pub. Date: Apr. 23, 2026

(54) USER-DEFINED BATTERY LIFE IN INFORMATION HANDLING SYSTEMS

(71) Applicant: Dell Products L.P., Round Rock, TX (US)

(72) Inventors: Suraj M Varma, Portland, OR (US); Kearson M. McNulty, Austin, TX (US); Marcus Daniel Molner, Austin, TX (US)

(73) Assignee: Dell Products L.P., Round Rock, TX (US)

(21) Appl. No.: 18/922,776

(22) Filed: Oct. 22, 2024

(51) Int. Cl. G06F 1/3203

(52) U.S. Cl. CPC G06F 1/3203

(57) ABSTRACT

Methods and systems include operation of an Information Handling System (IHS) that supports user defined battery life for charge stored in one or more rechargeable batteries of the IHS. A request by a user of the IHS is detected for operation of the IHS for a first duration using only power from the rechargeable batteries. In response, use of the power stored in the rechargeable batteries is configured such that the life of the rechargeable batteries is at least as long as the first duration specified by the user.

### FIELD

This disclosure relates generally to Information Handling Systems (IHSs), and more specifically, to managing power in portable IHSs.

### BACKGROUND

As the value and use of information continues to increase, individuals and businesses seek additional ways to process and store information. One option is an Information Handling System (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, global communications, etc. In addition, IHSs may include a variety of hardware and software components that may be configured to process, store, and communicate information and may include one or more computer systems, data storage systems, and networking systems.

Certain IHSs, such as laptops, tablets and mobile phones, are portable and are designed to operate using DC power supplied by rechargeable batteries. These batteries of portable IHSs are commonly recharged using an AC adapter that is plugged into an AC outlet and provides a portable IHS with a regulated supply of DC power. When not coupled to an AC adapter, portable IHSs may continue operating by drawing power from such rechargeable batteries. IHS may include various capabilities for reducing the power that is drawing from these rechargeable batteries, thus extending the time the IHS can operate before having to recharge the batteries.

### SUMMARY

In various embodiments, methods and systems include operation of an Information Handling System (IHS) that includes: one or more rechargeable batteries; one or more processors; a memory device coupled to the one or more processors, the memory device storing computer-readable instructions that, upon execution by the one or more processors, cause the IHS to: detect a request by a user of the IHS for operation of the IHS for a first duration using only power from the rechargeable batteries; and configure use of the power stored in the rechargeable batteries such that the life of the rechargeable batteries is at least as long as the first duration specified by the user.

In some embodiments, execution of the stored instructions further causes the IHS to: upon detecting the request by the user: determine a predicted duration of the power in the rechargeable batteries; determine whether the predicted duration is less than the first duration requested by the user; and when the predicted duration is less than the first duration, initiate power recovery operations. In some embodiments, the power recovery operations comprise determining a power deficit between the first duration requested by the user and the predicted duration. In some embodiments, a first set of power recovery operations supported by the IHS are initiated in response to determining the power deficit is less than a first threshold and a second set of power recovery operations supported by the IHS are initiated in response to determining the power deficit of greater than the first threshold. In some embodiments, execution of the stored instructions further causes the IHS to provide a first prompt to the user for requesting operation of the IHS for the first duration using only power from the rechargeable batteries. In some embodiments, the first prompt is provided to the user upon detecting the IHS is operating using only power from the rechargeable batteries. In some embodiments, execution of the stored instructions further causes the IHS to, in response to the user responding to the first prompt with the first duration, provide a second prompt to the user for prioritizing use of power from the rechargeable batteries during the first duration. In some embodiments, the second prompt provides the user with abilities to prioritize use of power from the rechargeable batteries to at least one of: an application operating on the IHS, a hardware component of the IHS, a subsystem of the IHS, and a device coupled to the IHS.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a block diagram depicting certain components of an IHS operable according to various embodiments for supporting a user-defined battery life in drawing power from rechargeable batteries of the IHS.

FIG. 2 is a flow chart diagram illustrating certain steps of a process according to various embodiments for providing a user-defined battery life in drawing power from rechargeable batteries of an IHS.

FIG. 3 is a flow chart diagram illustrating certain additional steps of a process according to various embodiments for providing a user-defined battery life in drawing power from rechargeable batteries of an IHS.

### DETAILED DESCRIPTION

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources, such as a Central Processing Unit (CPU) or hardware or software control logic, Read-Only Memory (ROM), and/or other types of nonvolatile memory.

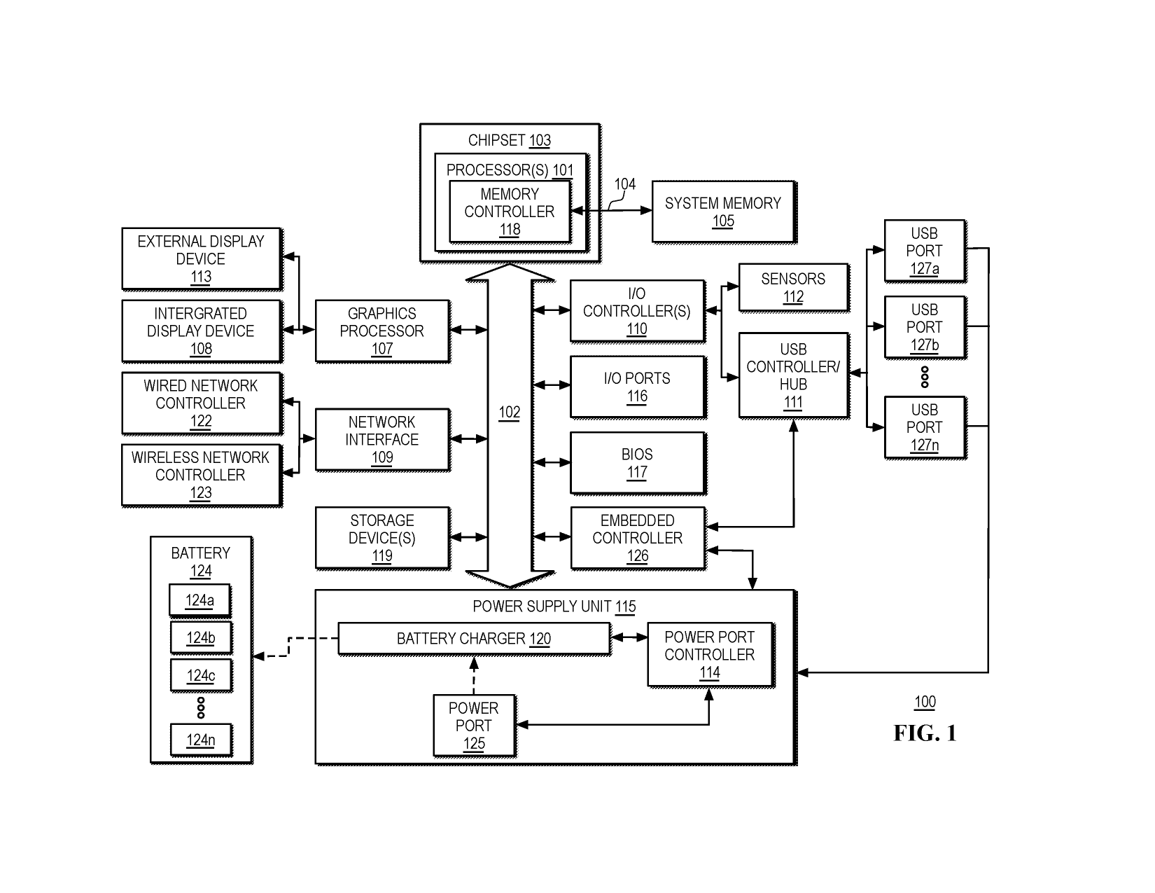

Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components. An example of an IHS is described in more detail below. FIG. 1 shows an example of an IHS configured to implement the systems and methods described herein according to certain embodiments. It should be appreciated that although certain IHS embodiments described herein may be discussed in the context of a personal computing device, other embodiments may be utilized.

FIG. 1 is a block diagram depicting certain components of an IHS 100 operable according to various embodiments for supporting a user-defined battery life in drawing power from rechargeable batteries 124 of the IHS 100. As described in additional detail below, IHS 100 may be configured to prompt the user of the IHS to specify a requested duration for the IHS to operate using only power drawn from the rechargeable batteries 124. For instance, the user may request for the available power to be used such that the IHS remains operational without external power for six hours, such as to accommodate a plane flight. In another instance, the user may request use of available battery 124 power for only an hour, such as to accommodate a remote meeting where the user wants maximum performance capabilities of the IHS during that hour. In various embodiments, IHS 100 may include an embedded controller 126 that includes logic that executes program instructions, in conjunction with operations by components of power supply unit 115 and the operating system of IHS 100, to perform the operations disclosed herein for supporting a user-defined battery life in drawing power from rechargeable batteries 124 of the IHS.

IHS 100 includes one or more processors 101, such as a Central Processing Unit (CPU), that execute code retrieved from a system memory 105. Although IHS 100 is illustrated with a single processor 101, other embodiments may include two or more processors, that may each be configured identically, or to provide specialized processing functions. Processor 101 may include any processor capable of executing program instructions, such as an Intel Pentium™ series processor or any general-purpose or embedded processors implementing any of a variety of Instruction Set Architectures (ISAs), such as the x86, POWERPC^{®}, ARM^{®}, SPARC^{®}, or MIPS^{®} ISAs, or any other suitable ISA.

In the embodiment of FIG. 1, the processor 101 includes an integrated memory controller 118 that may be implemented directly within the circuitry of the processor 101, or the memory controller 118 may be a separate integrated circuit that is located on the same die as the processor 101. The memory controller 118 may be configured to manage the transfer of data to and from the system memory 105 of the IHS 100 via a high-speed memory interface 104. The system memory 105 that is coupled to processor 101 provides the processor 101 with a high-speed memory that may be used in the execution of computer program instructions by the processor 101. Accordingly, system memory 105 may include memory components, such as such as static RAM (SRAM), dynamic RAM (DRAM), NAND Flash memory, suitable for supporting high-speed memory operations by the processor 101. In certain embodiments, system memory 105 may combine both persistent, non-volatile memory and volatile memory. In certain embodiments, the system memory 105 may be comprised of multiple removable memory modules.

IHS 100 utilizes a chipset 103 that may include one or more integrated circuits that are connect to processor 101. In the embodiment of FIG. 1, processor 101 is depicted as a component of chipset 103. In other embodiments, all of chipset 103, or portions of chipset 103 may be implemented directly within the integrated circuitry of the processor 101. Chipset 103 provides the processor(s) 101 with access to a variety of resources accessible via bus 102. In IHS 100, bus 102 is illustrated as a single element. Various embodiments may utilize any number of buses to provide the illustrated pathways served by bus 102.

As illustrated, a variety of resources may be coupled to the processor(s) 101 of the IHS 100 through the chipset 103. For instance, chipset 103 may be coupled to a network interface 109 that may support different types of network connectivity. In certain embodiments, IHS 100 may include one or more Network Interface Controllers (NICs), each of which may implement the hardware required for communicating via a specific networking technology, such as Wi-Fi, BLUETOOTH, Ethernet and mobile cellular networks (e.g., CDMA, TDMA, LTE). As illustrated, network interface 109 may support network connections by wired network controllers 122 and wireless network controller 123. Each network controller 122, 123 may be coupled via various buses to the chipset 103 of IHS 100 in supporting different types of network connectivity, such as the network connectivity utilized by applications of the operating system of IHS 100.

Chipset 103 may also provide access to one or more display device(s) 108, 113 via graphics processor 107. In certain embodiments, graphics processor 107 may be comprised within a video or graphics card or within an embedded controller installed within IHS 100. In certain embodiments, graphics processor 107 may be integrated within processor 101, such as a component of a system-on-chip. Graphics processor 107 may generate display information and provide the generated information to one or more display device(s) 108, 113 coupled to the IHS 100. The one or more display devices 108, 113 coupled to IHS 100 may utilize LCD, LED, OLED, or other display technologies. Each display device 108, 113 may be capable of receiving touch inputs such as via a touch controller that may be an embedded component of the display device 108, 113 or graphics processor 107, or may be a separate component of IHS 100 accessed via bus 102. As illustrated, IHS 100 may support an integrated display device 108, such as a display integrated into a laptop, tablet, 2-in-1 convertible device, or mobile device. In some embodiments, IHS 100 may be a hybrid laptop computer that includes dual integrated displays incorporated in both of the laptop panels. IHS 100 may also support use of one or more external displays 113, such as external monitors that may be coupled to IHS 100 via various types of couplings.

In certain embodiments, chipset 103 may utilize one or more I/O controllers 110 that may each support hardware components such as user I/O devices and sensors 112. For instance, I/O controller 110 may provide access to one or more user I/O devices such as a keyboard, mouse, touchpad, touchscreen, microphone, speakers, camera and other input and output devices that may be coupled to IHS 100. Each of the supported user I/O devices may interface with the I/O controller 110 through wired or wireless connections. In certain embodiments, sensors 112 accessed via I/O controllers 110 may provide access to data describing environmental and operating conditions of IHS 100. For instance, sensors 112 may include geo-location sensors capable for providing a geographic location for IHS 100, such as a GPS sensor or other location sensors configured to determine the location of IHS 100 based on triangulation and network information. Various additional sensors, such as optical, infrared and sonar sensors, that may provide support for xR (virtual, augmented, mixed reality) sessions hosted by the IHS 100. Such sensors 112 may capabilities for detecting when a user is detected within a certain proximity to IHS 100. For instance, sensors 112 may detect when a user is in close proximity to the IHS 100 and, in some cases, whether the user is facing the display(s) 108, 113. Sensors 112 may also detect when a user is not in close proximity to the IHS 100, but is nonetheless sufficiently nearby that the user may still be actively using IHS 100, such as by monitoring the progress of an application running on an IHS from across the room.

As illustrated, I/O controllers 110 may include a USB controller 111 that, in some embodiments, may also implement functions of a USB hub. In some embodiments, USB controller 111 may be a dedicated microcontroller that is coupled to the motherboard of IHS 100. In other embodiments, USB controller 111 may be implemented as a function of another component, such as a component of a SoC (System on Chip) of IHS 100, embedded controller 126, processors 101 or of an operating system of IHS 100. USB controller 111 supports communications between IHS 100 and one or more USB devices coupled to IHS 100, whether the USB devices may be coupled to IHS 100 via wired or wireless connections. In some embodiments, a USB controller 111 may operate one or more USB drivers that detect the coupling of USB devices and/or power inputs to USB ports 127a-n. USB controller 111 may include drivers that implement functions for supporting communications between IHS 100 and coupled USB devices, where the USB drivers may support communications according to various USB protocols (e.g., USB 2.0, USB 3.0). In providing functions of a hub, USB controller 111 may support concurrent couplings by multiple USB devices via one or more USB ports 127a-n supported by IHS 100.

In some embodiments, USB controller 111 may control the distribution of both data and power transmitted via USB ports 127a-n. For instance, USB controller 111 may support data communications with USB devices that are coupled to the USB ports 127a-n according to data communication protocols set forth by USB standards. The power transmissions supported by USB controller 111 may include incoming charging inputs received via USB ports 127a-n, as well as outgoing power outputs that are transmitted from IHS 100 to USB devices that are coupled to USB ports 127a-n. In some embodiments, USB controller 111 may interoperate with embedded controller 126 in routing power inputs received via USB ports 127a-n to a battery charger 120 supported by the power supply unit 115 of IHS 100 and in routing power outputs from battery 124 to devices coupled to USB ports 127a-n. In some instances, power outputs provided from battery 124 to devices coupled to USB ports 127a-n may be supported by high-performance battery modes that may be used to rapidly charge the batteries of a device coupled to a USB port 127a-n. As described in additional detail below, the use of such high-performance battery modes may be enabled, disabled or limited by embodiments based on user inputs specifying a requested duration for the power currently available in rechargeable batteries 124.

Other components of IHS 100 may include one or more I/O ports 116 that support removeable couplings with various types of peripheral external devices. I/O ports 116 may include various types of ports and couplings that support connections with external devices and systems, either through temporary couplings via ports, such as HDMI ports, accessible to a user via the enclosure of the IHS 100, or through more permanent couplings via expansion slots provided via the motherboard or via an expansion card of IHS 100, such as PCIe slots.

Chipset 103 also provides processor 101 with access to one or more storage devices 119. In various embodiments, storage device 119 may be integral to the IHS 100, or may be external to the IHS 100. In certain embodiments, storage device 119 may be accessed via a storage controller that may be an integrated component of the storage device. Storage device 119 may be implemented using any memory technology allowing IHS 100 to store and retrieve data. For instance, storage device 119 may be a magnetic hard disk storage drive or a solid-state storage drive. In certain embodiments, storage device 119 may be a system of storage devices, such as a cloud drive accessible via network interface 109.

As illustrated, IHS 100 also includes a BIOS (Basic Input/Output System) 117 that may be stored in a non-volatile memory accessible by chipset 103 via bus 102. In some embodiments, BIOS 117 may be implemented using a dedicated microcontroller coupled to the motherboard of IHS 100. In some embodiments, BIOS 117 may be implemented as operations of embedded controller 126. Upon powering or restarting IHS 100, processor(s) 101 may utilize BIOS 117 instructions to initialize and test hardware components coupled to the IHS 100. The BIOS 117 instructions may also load an operating system for use by the IHS 100. The BIOS 117 provides an abstraction layer that allows the operating system to interface with the hardware components of the IHS 100. The Unified Extensible Firmware Interface (UEFI) was designed as a successor to BIOS. As a result, many modern IHSs utilize UEFI in addition to or instead of a BIOS. As used herein, BIOS is intended to also encompass UEFI.

Some IHS 100 embodiments may utilize an embedded controller 126 that may be a motherboard component of IHS 100 and may include one or more logic units. In certain embodiments, embedded controller 126 may operate from a separate power plane from the main processors 101, and thus from the operating system functions of IHS 100. In some embodiments, firmware instructions utilized by embedded controller 126 may be used to operate a secure execution environment that may include operations for providing various core functions of IHS 100, such as power management and management of certain operating modes of IHS 100.

Embedded controller 126 may also implement operations for interfacing with a power supply unit 115 in managing power for IHS 100. In certain instances, the operations of embedded controller may determine the power status of IHS 100, such as whether IHS 100 is operating strictly from battery power, whether any charging inputs are being received by power supply unit 115, and/or the appropriate mode for charging the one or more battery cells 124a-n using the available charging inputs. Embedded controller 126 may support routing and use of power inputs received via a USB port 127a-n and/or via a power port 125 supported by the power supply unit 115. In addition, operations of embedded controller 126 may interoperate with power supply unit 115 in order to provide battery status information, such as the charge level of the cells 124a-n of battery 124.

In some embodiments, embedded controller 126 may also interface with power supply unit 115 in monitoring the battery state of battery 124, such as the relative state of charge of battery 124, where this charge level of the battery 124 may be specified as a percentage of the full charge capacity of the battery 124. In some instance, when operating from power stored in battery system 124, embedded controller 126 may detect when the voltage of the battery system 124 drops below a low-voltage threshold. When the charge level of battery 124 drops below such a low-voltage threshold, embedded controller 126 may transition the IHS to an off-power state in implementing a battery protection mode that preserves a minimal power level in battery 124.

Embedded controller 126 may also implement operations for detecting certain changes to the physical configuration of IHS 100 and managing the modes corresponding to different physical configurations of IHS 100. For instance, where IHS 100 is a laptop computer or a convertible laptop computer, embedded controller 126 may receive inputs from a lid position sensor that may detect whether the two sides of the laptop have been latched together, such that the IHS is in a closed position. In response to lid position sensor detecting latching of the lid of IHS 100, embedded controller 126 may initiate operations for shutting down IHS 100 or placing IHS 100 in a low-power mode.

In this manner, IHS 100 may support the use of various power modes. In some embodiments, the power modes of IHS 100 may be implemented through operations of the embedded controller 126 and power supply unit 115. In various embodiments, a mobile IHS 100 may support various low power modes in order to reduce power consumption and/or conserve power stored in battery 124. The power modes may include a fully on state in which all, or substantially all, available components of mobile IHS 100 may be fully powered and operational. In a fully off mode, processor(s) 101 may powered off, any integrated storage devices 119 may be powered off, and/or integrated displays 108 may be powered off. In an intermediate low-power mode, various components of mobile IHS 100 may be powered down, but mobile IHS 100 remains ready for near-immediate use. In a standby power mode, which may be referred to as a sleep state or hibernation state, state information may be stored to storage devices 119 and all but a selected set of components and low-power functions of mobile IHS 100, such as standby functions supported by embedded controller 126, are shut down.

In some embodiments, IHS 100 may include various high-power battery modes that may be used to support peak power demands for short durations. Such high-power battery modes allow the IHS to support high-performance computing tasks, but may result in rapid discharge of available battery power. Embodiments provide capabilities for selectively utilizing such battery modes in a manner that preserves the charge of batteries 124 within limits set forth by the user in requesting operation of the IHS for a specific duration while using only charge from batteries 124, and thus without recharging of the batteries. As described in additional detail below, embodiments may manage use of high-performance battery modes though prioritization of use of available power, where this prioritization may be specified by the user. Based on user-specified priorities, the charge in rechargeable batteries 124 may be prioritized for use by: software applications running on the IHS, specific hardware components of IHS, and/or specific subsystems operating on the IHS.

As described, IHS 100 may also include a power supply unit 115 that receives power inputs used for charging batteries 124 from which the IHS 100 operates. IHS 100 may include a power port 125 to which an AC adapter may be coupled to provide IHS 100 with a supply of DC power. The DC power input received at power port 125 may be utilized by a battery charger 120 for recharging one or more internal batteries 124 of IHS 100. As illustrated, batteries 124 utilized by IHS 100 may include one or more cells 124a-n that may connected in series or in parallel. Power supply unit 115 may support various modes for charging the cells 124a-n of battery 124 based on the power supply available to IHS 100 and based on the charge levels of the battery system 124. In certain embodiments, power supply unit 115 of IHS 100 may include a power port controller 114 that is operable for configuring operations by power port 125. In certain embodiments, power port controller 114 may be an embedded controller that is a motherboard component of IHS 100, a function supported by a power supply unit 115 embedded controller, or a function supported by a system-on-chip implemented by processors 101.

In various embodiments, an IHS 100 does not include each of the components shown in FIG. 1. In various embodiments, an IHS 100 may include various additional components in addition to those that are shown in FIG. 1. Furthermore, some components that are represented as separate components in FIG. 1 may in certain embodiments instead be integrated with other components. For example, in certain embodiments, all or a portion of the functionality provided by the illustrated components may instead be provided by components integrated into the one or more processor(s) 101 as a systems-on-a-chip.

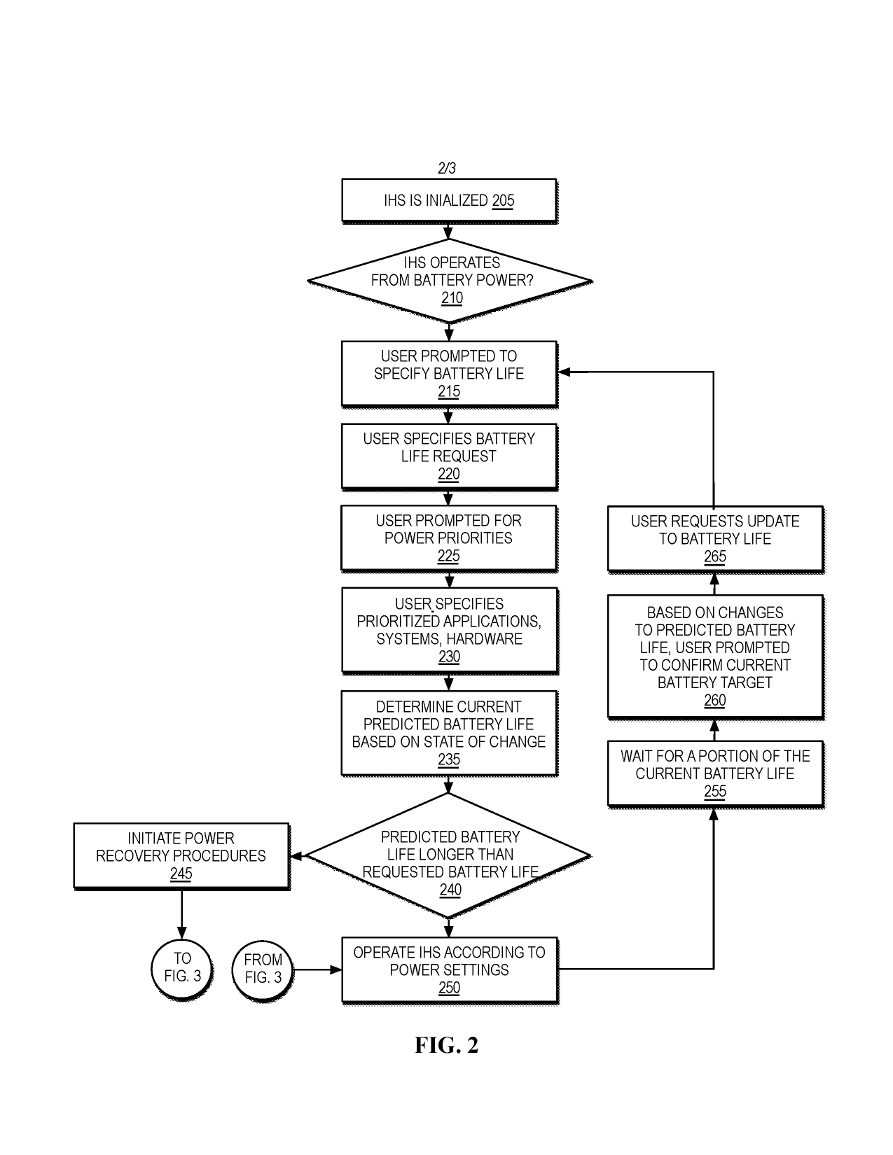

FIG. 2 is a flow chart diagram illustrating certain steps of a process according to various embodiments for supporting a user-defined battery life in drawing power from rechargeable batteries of an IHS 100. As illustrated, embodiments may begin at block 205 with the initialization of an IHS, such as the IHS 100 described with regard to FIG. 1. Once the IHS has been initialized and the operating system of the IHS is booted, the user may commence operation of the IHS and may thus initiate use of software applications that are supported by the operating system of the IHS. The IHS may be operated for any amount of time in the manner, when, at 210, embodiments determine that the IHS is operating only from power provided by rechargeable batteries 124.

As described above, IHS 100 may include an embedded controller 126 or other controller that detects when the IHS is coupled to an external power source, or when the IHS is operating solely from power available in rechargeable batteries 124. In response to detecting operation of the IHS solely from battery power, at 215, the user of the IHS 100 may be prompted to specify a requested battery life for the current interval where the IHS is operating only from battery power. In some embodiments, this prompt may be generated and presented to the user by the operating system of the IHS, operating in conjunction with the embedded controller 126. In some embodiments, this prompt may provide the user with the current predicted battery life, such as determined by the embedded controller 126 through queries to the power supply unit 115 of the IHS.

In some instances, the user may decline to specify any requested duration for the current battery life of rechargeable batteries 124, such as in a scenario where the user is only temporarily unplugging the IHS from an external power source. However, in other scenarios, at 220, the user may specify a requested duration for operation of the IHS 100 using only from power currently available in the rechargeable batteries 124. For instance, the user may request a battery life of eight hours, such as accommodate a long plane flight without external power availability. In other instances, the user may request a shorter battery life, such as requesting a battery life of four hours to accommodate a period of remote work. In other instance, the user may request a short battery life, such as requesting a battery life of one hour to accommodate a gaming session where the user wants full performance of the IHS during this hour.

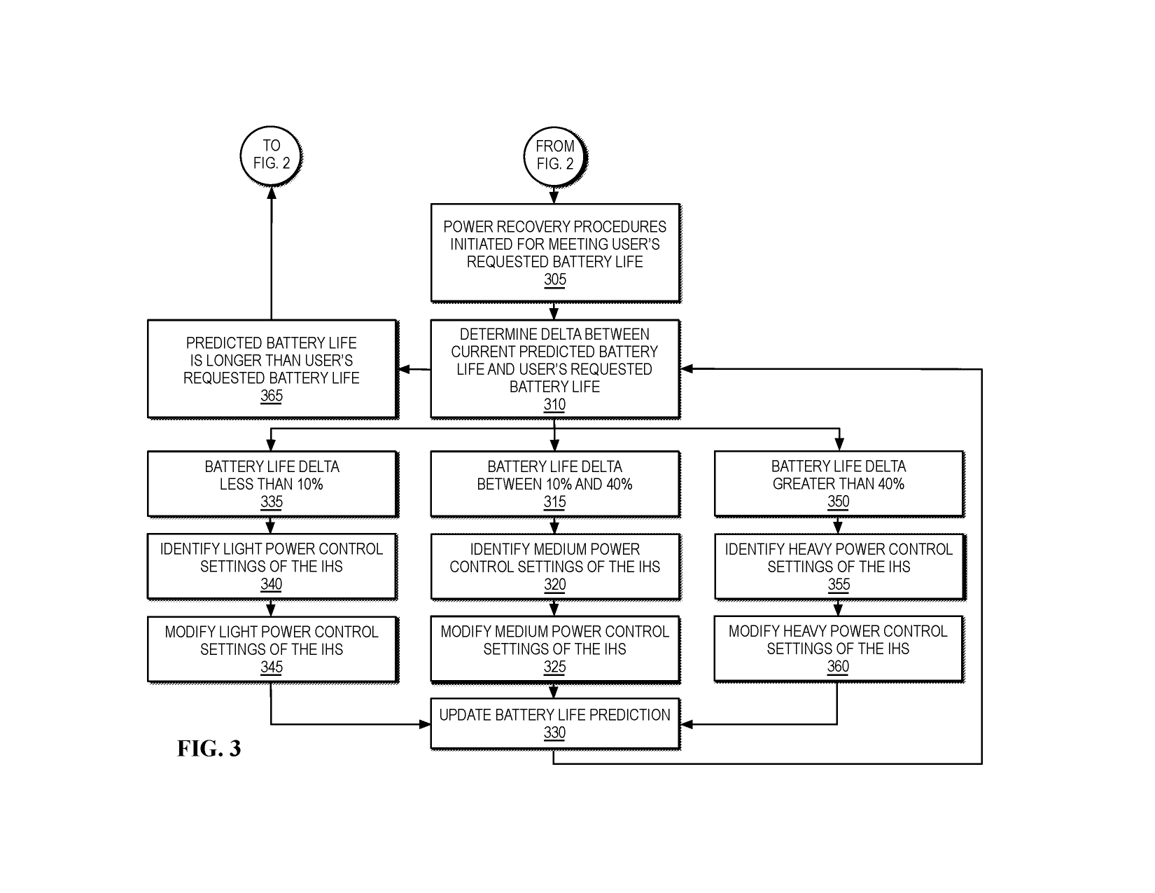

As indicated in FIG. 3, in some embodiments, in response to the user specifying a requested battery life duration, at 225, the user may be prompted to provide a set of power priorities of use of power during this requested duration. As with the first prompt, the second prompt may be provided to the user via the operating system, in conjunction with the embedded controller 126, which may provide a listing of the available power prioritizations that are supported. For instance, the prompt provided to the user may specify a list of user applications currently operating on the IHS for which power use may be prioritized, such as a prompt allowing a user to prioritize a gaming application, a CAD application, a multimedia player or other user application.

In some embodiments, the prompt provided to the user may specify a list of subsystems of the IHS to be prioritized with respect to use of available battery power during the requested battery life duration. For instance, the prompt may specify a gaming subsystem operating on the IHS that may be prioritized, with the gaming subsystem consisting of the gaming application, a graphics processor 107, one or more gaming controllers coupled to the IHS and/or gaming operations supported by the keyboard, trackpad, displays and other integrated user I/O devices coupled to the IHS. In another illustrative example, the prompt may specify a presentation subsystem operating on the IHS that may be prioritized, with this subsystem consisting of presentation application, a graphics processor 107 and I/O controllers used by the presentation application, such as use of Bluetooth controller for interfacing with a laser pointer and/or remote presentation controller operated by the user.

In some embodiments, the prompt provided to the user may specify a list of hardware components of the IHS to be prioritized with respect to use of available battery power during the requested battery life duration. For instance, the prompt may specify one or more hardware devices of the IHS for which power may be prioritized. In some embodiments, this hardware that may be prioritized may include integrated hardware, such as in integrated graphics processor 107 or an integrated display. In some embodiments, this hardware that may be prioritized may include external devices that are coupled to the IHS. For instance, as described above, an IHS 100 may include USB ports 127a-n by which external devices may be coupled to the IHS, and in some instances may draw power from the IHS. In such instances, embodiments may include such devices drawing power from the IHS in the list of hardware that may be prioritized.

At 230, the user may select from the software, hardware and/or systems included in the prompt in specifying priorities with regard to use of power during the battery life duration that was requested by the user. Once the user has provided the requested battery life duration and specified in any power priorities, embodiments may initiate procedures for re-configuring power consumption of the IHS to accommodate the requested battery life duration. These procedures may begin, at 235, with the IHS determining the current predicted life of the rechargeable batteries 124 based on their current state of charge and based on the current power settings of the IHS. As described in additional detail with regard to FIG. 3, a variety of different settings of the IHS may determine the amount of power that is drawn from the rechargeable batteries 124.

As indicated in FIG. 2, once the predicted battery life duration has been determined, at 240, this predicated duration is compared against the battery life duration that was requested by the user. In some instances, the current power settings of the IHS result in a predicted battery life duration that is as long as, or longer than, the requested battery life duration specified by the user. In such instances, no power adjustments are currently necessary in order to the IHS to provide the user with the requested battery life duration. Accordingly, in such instances, at 250, the IHS 100 may be operated according to its current power settings. In some embodiments, the power settings of the IHS may be modified according to any power priorities specified by the user, such as to prioritize use of available power by a gaming subsystem of the IHS.

Although an initial predicted battery life duration may be longer than the requested battery life duration, the projected battery life may change based on various factors as the IHS is operated. For instance, ongoing use of the IHS by the user may result in depletion of the rechargeable batteries 124 faster than anticipated. For example, the user may launch and being use of a software application that consumes significant amounts of processing and storage resources of the IHS, thus resulting in a significant increase in power use by the IHS. Accordingly, as indicated in FIG. 2, at 225, embodiments may wait for a predefined interval in order to being periodic evaluation of the updated predicted battery life duration in order to ensure the predicted battery life remains long enough to satisfy the battery life duration requested by the user.

In some embodiments, the interval used for periodic re-evaluation of the predicted battery life duration may be a specific time interval, such as every five minutes. In some embodiments, this interval may be a percentage of the most recent predicted battery life duration. For example, the interval for re-evaluation may be after ten percent of the most recent battery life prediction has elapsed. In some embodiments, this interval for periodic re-evaluation may be triggered by events detected in the ongoing use of the IHS. For instance, a defined time interval for the next re-evaluation may be interrupted upon detecting an event that will increase the power consumption of the IHS, such as the launching of a new application. In some embodiments, such events may be detected through monitoring the transmission of ACPI (Advanced Configuration and Power Interface) messages, such as a message transmitted in response to the detection of an external device being coupled to the IHS.

After the expiration of an interval and/or in response to a detected power event, an updated battery life prediction may be requested and embodiments may determine whether there has been a significant change in the predicted battery life duration. If there has been any significant change, at 260, the user may be prompted to confirm their prior requested battery life duration. As with the prior prompts, the prompt may be presented via the operating system of the IHS 100 operating in conjunction with the embedded controller 126. In some embodiments, the prompt provided to the user may also include a notification that the predicted current battery life is now less than the user’s requested battery life duration. In response to the presented prompt, at 265, the user may request an update to their requested battery life duration. Embodiments thus return, at 215, to the prompt that allows the user to specify their updated requested battery life duration. Based on this updated requested battery life duration, embodiments continue with the evaluation of the predicted battery life versus the updated battery life duration request from the user. Embodiments may use this updated battery life duration request and updated predicted battery life in making power setting adjustments according to another iteration of the procedures described in FIGS. 2 and 3. Embodiments may rely on prior power prioritizations from the user and may defer requests for updates to the power prioritizations from the user on subsequent iterations.

Whether in the first iterations or later iterations, in scenarios where the predicted battery life duration is shorter than the user’s requested battery life duration, at 245, embodiments may initiate procedures for recovery of available power in a manner that recovers available battery life based on the current state of charge of the rechargeable batteries 124. As indicated in FIG. 2, embodiments may continue to FIG. 3 for power recovery procures. FIG. 3 is a flow chart diagram illustrating certain aspects of power recovery procedures, according to various embodiments, for providing a user-defined battery life in drawing power from rechargeable batteries of an IHS.

In FIG. 3, at 305, embodiments may begin power recovery procedures in order to satisfy the battery life duration requested by the user. In order to begin procedures for extending the current predicted battery life duration, at 310, embodiments may calculate the time difference between the predicted battery life duration and the user’s requested battery life duration. This time delta establishes the magnitude of the power deficit that must be recovered in order for the current state of charge of rechargeable batteries 124 to provide the battery life duration requested by the user. As indicated in FIG. 3, embodiments may begin by characterizing this power deficit based on it’s magnitude. Although the illustrated embodiment utilizes three power deficit classifications in classifying the magnitude of the power deficit, other embodiments may utilize any number of such power deficit classifications.

In the illustrated embodiment, at 335, the power deficit is determined to be less than ten percent threshold in one of the available power deficit classification that corresponds to the smallest range of power deficits. Other embodiments may utilize other power deficit threshold values in the same manner. For this ten percent threshold, the shortfall of the predicted battery life duration from the user’s requested battery life duration is ten or less percent of the user’s requested battery life duration. For example, there is a ten percent delta between a predicted battery life of four and half hours and the user’s requested battery life duration of five hours. Such a power deficit classification may correspond to the smallest range of power deficits and may thus result in embodiments initiating the most granular power setting adjustments that are supported by the IHS 100.

Accordingly, at 340, embodiments may identify one or more low-power control settings of the IHS 100 that can be used for making relatively small adjustments to power consumption by the IHS. In some embodiments, these power settings adjustments that provide the lowest range of power savings may include migration of processing threads from the main system processor of the IHS to a low-power processor or processor core, or in some instances to migrate the thread to a remote resource, such as a cloud processing resource. In some embodiments, power settings adjustments providing the lowest range of power savings may include reducing use of certain cache memories of the IHS that provide improved responsiveness, but at the cost of increased power consumption that is required to keep these cache memories energized. In some embodiments, power settings adjustments providing the lowest range of power savings may include adjustments to the clock speed of one or more processors of the IHS.

Embodiments may utilize any number of such low-power adjustments in the lowest of the power deficit classifications. Based on these available low-power adjustments, embodiments may iteratively select from the available low-power adjustments in reducing the power consumption of the IHS by the size of the power deficit. Some embodiments may select and initiate single low-power power settings adjustments at a time, while other embodiments may select groups of power setting adjustments. As described above, in addition to specifying a requested battery life duration, the user may also specify priorities for use of available power during this duration. Embodiments may select from the available low-power power deficit adjustments based on these prioritizations, such as deferring movement of a thread corresponding to an application and/or subsystem selected for prioritization by the user.

At 345, the selected low-power adjustments of the IHS are made, such as through operations of the operating system in conjunction with the embedded controller 126 of the IHS. Once the selected low-power adjustments have been made, at 330, the predicted battery life duration is updated and embodiments return, at 310, to evaluation of the updated delta between the requested battery life duration and the updated predicted battery life duration. In this manner, embodiments may make a series of low-power adjustments that result power savings resulting in the predicted battery life duration being extended such that it is longer than the user’s requested battery life duration.

As indicated at 315 in FIG. 3, in some scenarios, the power deficit may fall within a mid-level classification, such as a power deficit determined to be between ten percent and forty percent of the user’s requested battery life duration. In light of the greater magnitude of the power deficit, embodiments may initiate power setting adjustments supported by the IHS that are likewise greater in magnitude. Accordingly, at 320, embodiments may identify one or more medium-level power control settings of the IHS 100 for making larger adjustments to power consumption by the IHS.

In some embodiments, these medium-level settings adjustments may include making changes to power modes supported by various hardware components of the IHS. For instance, a system processor 101 may support various power modes through which redundant processor cores may be shut down and/or different memory settings may be utilized. Other processors, such as a graphics processor 107 and network controllers 122, 123, may similarly support low power settings. Certain storage devices 119 may support low power operating modes. A USB controller 111 may be configured to reduce or eliminate delivery of power to certain USB devices that are coupled to the IHS and to reduce its own power consumption. In some embodiments, medium-level power settings adjustments may include modifications to operations of the cooling system of the IHS, such as reducing fan speeds.

Embodiments may utilize any number of such medium-level power deficit adjustments. Based on the available medium-level power adjustments, embodiments may iteratively select power adjustments in attempting to reduce the power consumption of the IHS by the size of the power deficit. Embodiments may select and initiate single medium-level power settings adjustments at a time, or may select groups of medium-level power setting adjustments. As with the low-power adjustments, embodiments may select from the available medium-power power deficit adjustments based on prioritizations specified by the user, such as deferring modification of a power mode for a hardware component of subsystem selected for prioritization by the user (e.g., maintaining the current power setting a coupled USB gaming controller that is part of a gaming subsystem that has been prioritized). At 325, the selected medium-level power adjustments of the IHS are made, such as through operations of the operating system in conjunction with the embedded controller 126 of the IHS. Once the selected medium-level power adjustments have been made, at 330, the predicted battery life duration is updated and embodiments return, at 310, to evaluation of the updated delta between the requested battery life duration and the updated predicted battery life duration.

As indicated at 350 in FIG. 3, in some scenarios, the power deficit may fall within a highest-level classification, such as a power deficit determined to be between greater than forty percent of the user’s requested battery life duration. In light of the significant magnitude of the power deficit, embodiments may initiate the most aggressive power setting adjustments that are available. Accordingly, at 355, embodiments may identify one or more high-level power control settings of the IHS 100 for making the largest supported adjustments to power consumption by the IHS.

In some embodiments, these high-level settings adjustments may include use of screen dimming, both for integrate displays 108 and with regard to any other lighting, such as by an illuminated integrated keyboard. In some embodiments, high-level power settings adjustments may include shutting down certain hardware components of the IHS 100. For instance, significant power savings may be gained from shutting down an unused network controller, such as shutting down a Bluetooth short-range wireless network controller when no active connections are being supported. In some scenarios, a Wi-FI wireless network controller may similarly be shut down when not in use by any of the applications or systems prioritized by the user. Unused storage devices 119 may be completely shut down. Any remaining USB operations may be shut down. Use of available system memory 105 may be consolidated, thus reducing the number of memory modules that are being energized. In some embodiments, these high-power settings adjustments may include selection of different power modes supported by the power supply unit 115 and/or embedded controller 126, such as described with regard to FIG. 1.

Embodiments may utilize any number of such high-power deficit adjustments. Embodiments may iteratively select from the available high-power adjustments in attempting to reduce the power consumption of the IHS by the size of the power deficit. Embodiments may select and initiate single high-power settings adjustments at a time, or may select groups of high-power setting adjustments. As above, embodiments may select from the available high-power deficit adjustments based on user-specified prioritizations, such as deferring or minimizing screen dimming based on the user selecting prioritization of the multimedia subsystem. At 360, the selected high-power adjustments of the IHS are made, such as through operations of the operating system in conjunction with the embedded controller 126 of the IHS. Once the selected high-power adjustments have been made, at 330, the predicted battery life duration is updated and embodiments return, at 310, to evaluation of the updated delta between the requested battery life duration and the updated predicted battery life duration.

In this manner, embodiments may make a series of power adjustments that result power savings resulting in the predicted battery life duration being extended such that it is longer than the user’s requested battery life duration. A large power deficit may result in high-power adjustments may be made, thus reducing the power deficit such that medium-level power adjustments may be made, until only low-power adjustments are required to eliminate the power deficit entirely. Through such operations, embodiments may iteratively adjust the power settings of the IHS 100 until the predicted battery life duration is as long as the user’s requested battery life duration.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS) comprising:
one or more rechargeable batteries;
one or more processors;
a memory device coupled to the one or more processors, the memory device storing computer-readable instructions that, upon execution by the one or more processors, cause the IHS to:
detect a request by a user of the IHS for operation of the IHS for a first duration using only power from the rechargeable batteries; and
configure use of the power stored in the rechargeable batteries such that the life of the rechargeable batteries is at least as long as the first duration specified by the user.

2. The IHS of claim 1, wherein execution of the stored instructions further causes the IHS to:
upon detecting the request by the user:
determine a predicted duration of the power in the rechargeable batteries;
determine whether the predicted duration is less than the first duration requested by the user; and
when the predicted duration is less than the first duration, initiate power recovery operations.

3. The IHS of claim 2, wherein the power recovery operations comprise determining a power deficit between the first duration requested by the user and the predicted duration.

4. The IHS of claim 3, wherein a first set of power recovery operations supported by the IHS are initiated in response to determining the power deficit is less than a first threshold and a second set of power recovery operations supported by the IHS are initiated in response to determining the power deficit of greater than the first threshold.

5. The IHS of claim 1, wherein execution of the stored instructions further causes the IHS to provide a first prompt to the user for requesting operation of the IHS for the first duration using only power from the rechargeable batteries.

6. The IHS of claim 5, wherein the first prompt is provided to the user upon detecting the IHS is operating using only power from the rechargeable batteries.

7. The IHS of claim 5, wherein execution of the stored instructions further causes the IHS to, in response to the user responding to the first prompt with the first duration, provide a second prompt to the user for prioritizing use of power from the rechargeable batteries during the first duration.

8. The IHS of claim 7, wherein the second prompt provides the user with abilities to prioritize use of power from the rechargeable batteries to at least one of: an application operating on the IHS, a hardware component of the IHS, a subsystem of the IHS, and a device coupled to the IHS.

9. A method for powering an Information Handling System (IHS) comprising one or more rechargeable batteries, the method comprising:
detecting a request by a user of the IHS for operation of the IHS for a first duration using only power from the rechargeable batteries; and
configuring use of the power stored in the rechargeable batteries such that the life of the rechargeable batteries is at least as long as the first duration specified by the user.

10. The method of claim 9, further comprising, upon detecting the request by the user:
determining a predicted duration of the power in the rechargeable batteries;
determining whether the predicted duration is less than the first duration requested by the user; and
when the predicted duration is less than the first duration, initiating power recovery operations.

11. The method of claim 10, wherein the power recovery operations comprise determining a power deficit between the first duration requested by the user and the predicted duration.

12. The method of claim 11, wherein a first set of power recovery operations supported by the IHS are initiated in response to determining the power deficit is less than a first threshold and a second set of power recovery operations supported by the IHS are initiated in response to determining the power deficit of greater than the first threshold.

13. The method of claim 9, further comprising providing a first prompt to the user for requesting operation of the IHS for the first duration using only power from the rechargeable batteries.

14. The method of claim 13, wherein the first prompt is provided to the user upon detecting the IHS is operating using only power from the rechargeable batteries.

15. A computer-readable storage device having instructions stored thereon for powering an Information Handling System (IHS) comprising one or more rechargeable batteries, wherein execution of the instructions by one or more processors of the IHS causes the one or more processors to:
detect a request by a user of the IHS for operation of the IHS for a first duration using only power from the rechargeable batteries; and
configure use of the power stored in the rechargeable batteries such that the life of the rechargeable batteries is at least as long as the first duration specified by the user.

16. The computer-readable storage device of claim 15, wherein execution of the instruction causes the one or more processors, upon detecting the request by the user, to:
determine a predicted duration of the power in the rechargeable batteries
determine whether the predicted duration is less than the first duration requested by the user; and
when the predicted duration is less than the first duration, initiate power recovery operations.

17. The computer-readable storage device of claim 16, wherein the power recovery operations comprise determining a power deficit between the first duration requested by the user and the predicted duration.

18. The computer-readable storage device of claim 17, wherein a first set of power recovery operations supported by the IHS are initiated in response to determining the power deficit is less than a first threshold and a second set of power recovery operations supported by the IHS are initiated in response to determining the power deficit of greater than the first threshold.

19. The computer-readable storage device of claim 16, further comprising providing a first prompt to the user for requesting operation of the IHS for the first duration using only power from the rechargeable batteries.

20. The computer-readable storage device of claim 19, wherein the first prompt is provided to the user upon detecting the IHS is operating using only power from the rechargeable batteries.
